(19) United States
(12) Patent Application Publication
(10) Pub. No.: US 2026/0252250 A1
(43) Pub. Date: Aug. 27, 2026

(54) METHOD FOR ACQUIRING INFORMATION, DATA STORAGE SYSTEM, ELECTRONIC DEVICE, AND STORAGE MEDIUM

(71) Applicant: CLOUD INTELLIGENCE ASSETS HOLDING (SINGAPORE) PRIVATE LIMITED, Singapore (SG)

(72) Inventors: Zongpeng ZHU, Hangzhou, Zhejiang (CN); Anyu LI, ShenZhen, Guangdong (CN); Fangzhi WEN, ShenZhen, Guangdong (CN)

(21) Appl. No.: 19/128,962

(22) PCT Filed: Nov. 10, 2023
(86) PCT No.: PCT/CN2023/131111

§ 371 Date: May 9, 2025

(30) Foreign Application Priority Data
Nov. 10, 2022 (CN) 202211406563.1

(51) Int. Cl. G06F 3/06

(52) U.S. Cl. CPC G06F 3/0635; G06F 3/0604; G06F 3/0674

(57) ABSTRACT

A method and apparatus for acquiring information and, a data storage system, an electronic device, and a storage medium are provided. The method includes: acquiring disk information of each disk device in a storage system; acquiring first mounting information of a corresponding disk by using the disk identifier; establishing, based on an expander port address comprised in the first device information, a first corresponding relationship between the expander port address with the disk port address; in response to the first device information comprising an adapter identifier of an adapter upstream of the expander, establishing, based on an adapter port address corresponding to the adapter identifier, a second corresponding relationship between the adapter port address with the expander port address; and generating, based on the first corresponding relationship and the second corresponding relationship, device information for describing a topological relationship of the disk in the storage system.

### CROSS REFERENCE TO RELATED APPLICATIONS

The present disclosure is s a National Stage of International Application PCT/CN2023/131111, filed on Nov. 10, 2023, which claims priority to Chinese Patent Application No. 202211406563.1 entitled “INFORMATION ACQUISITION METHOD AND APPARATUS, STORAGE SYSTEM, DEVICE, AND MEDIUM”, filed with the China National Intellectual Property Administration (CNIPA) on Nov. 10, 2022, the entire contents of the mentioned applications are incorporated herein by reference.

### TECHNICAL FIELD

The present disclosure relates to the field of computer technologies, and in particular, to a method for acquiring information, a data storage system, an electronic device, and a storage medium.

### BACKGROUND

With a rapid development of computer technologies, there are increasing requirements for data storage. Especially, in a cloud computing scenario, to meet a data processing requirement, a powerful data storage system needs to be configured.

In a storage system, it is generally necessary to configure a plurality of mass storage disks. For example, in a storage cabinet, a plurality of disks are provided, and these disks are installed on an expander, and then connected to a server through a host bus adapter. In actual application, the disks, expanders, and the like in the storage cabinet may come from different manufacturers or belong to different models due to subsequent expansion requirements for disk upgrade and hardware performance differentiation. In order to facilitate precise management of each disk in the storage system, it is necessary to accurately determine location information of each disk in the storage cabinet. However, if the location information is to be acquired accurately and comprehensively, it needs to be supported and authorized by each hardware manufacturer. In addition, even if the support and authorization of the hardware manufacturers are obtained, corresponding information extraction and maintenance programs need to be developed for different manufacturers and different device models, which has low working efficiency and high investment cost.

### SUMMARY

To resolve or improve the problems existing in the related technologies, a method for acquiring information, a data storage system, an electronic device, and a storage medium are provided in the embodiments of the present disclosure.

According to a first aspect, a method for acquiring information is provided in an embodiment of the present disclosure. The method includes: acquiring disk information of each disk device in a storage system, where the disk information includes a disk identifier and a disk port address; acquiring first mounting information of a corresponding disk by using the disk identifier, where the first mounting information includes first device information of an expander upstream of the disk; establishing, based on an expander port address included in the first device information, a first corresponding relationship between the expander port address with the disk port address; in response to the first device information including an adapter identifier of an adapter upstream of the expander, establishing, based on an adapter port address corresponding to the adapter identifier, a second corresponding relationship between the adapter port address with the expander port address; and generating, based on the first corresponding relationship and the second corresponding relationship, device information for describing a topological relationship of the disk in the storage system.

According to a second aspect, a data storage system is provided in an embodiment of the present disclosure, including a client, configured to send a request for acquiring device information to a server; a server, configured to: in response to the request for acquiring device information, acquire disk information of each disk device in a storage system, where the disk information includes a disk identifier and a disk port address; acquire first mounting information of a corresponding disk by using the disk identifier, where the first mounting information includes first device information of an expander upstream of the disk; establish, based on an expander port address included in the first device information, a first corresponding relationship between the expander port address with the disk port address; in response to the first device information including an adapter identifier of an adapter upstream of the expander, establish, based on an adapter port address corresponding to the adapter identifier, a second corresponding relationship between the adapter port address with the expander port address; and generate, based on the first corresponding relationship and the second corresponding relationship, device information for describing a topological relationship of the disk in the storage system; and a storage cabinet, including the adapter, the expander, and the disk, and configured to be connected to the server through one or more adapters, where one or more adapters and a plurality of disks are sequentially connected downstream of each of the adapters.

According to a third aspect, an electronic device is provided in an embodiment of the present disclosure, including a non-transitory storage and a processor, where the non-transitory storage is configured to store a program; the processor is coupled to the non-transitory storage, and is configured to execute the program stored in the non-transitory storage, to implement the method for acquiring information according to the first aspect.

According to a fourth aspect, a non-transitory machine-readable storage medium is provided in an embodiment of the present disclosure, having executable codes stored thereon, the executable codes, when executed by a processor of an electronic device, causing the processor to perform the method for acquiring information according to the first aspect.

### BRIEF DESCRIPTION OF DRAWINGS

In order to more clearly illustrate the technical solutions in the embodiments of this disclosure or related technologies, the following briefly describes the accompanying drawings that need to be used in the embodiments or related technical descriptions. Obviously, the drawings in the following description are some embodiments of the present disclosure, and for those of ordinary skill in the art, other drawings may be obtained according to these drawings without creative efforts.

FIG. 1 is a schematic structural diagram of a data storage system according to an embodiment of the present disclosure.

FIG. 2 is a schematic flowchart of a method for acquiring information in a storage system according to an embodiment of the present disclosure.

FIG. 3 is a schematic diagram of a topological relationship according to an embodiment of the present disclosure.

FIG. 4 is a schematic diagram of a topological relationship according to an embodiment of the present disclosure.

FIG. 5 is a schematic diagram of a topological structure according to an embodiment of the present disclosure.

FIG. 6 is a schematic structural diagram of a data storage system according to an embodiment of the present disclosure.

FIG. 7 is a schematic structural diagram of an apparatus for acquiring device information according to an embodiment of the present disclosure.

FIG. 8 is a schematic structural diagram of an electronic device according to an embodiment of the present disclosure.

### DETAILED DESCRIPTION

To make a person skilled in the art better understand the solutions of the present disclosure, the following clearly and completely describes the technical solutions in the embodiments of this disclosure with reference to the accompanying drawings in the embodiments of this disclosure.

Some processes described in the specification, claims, and accompanying drawings of the present disclosure include a plurality of operations that appear in a specific order, and these operations may be performed out of the order in which they appear in this specification or in parallel. The sequence numbers of the operations such as 101 and 102 are only used to distinguish different operations, and the sequence numbers themselves do not represent any execution order. In addition, these processes may include more or fewer operations, and these operations may be performed sequentially or in parallel. It should be noted that descriptions such as “first” and “second” in this specification are used to distinguish between different messages, devices, modules, and the like, and do not represent a sequence, and “first” and “second” are not limited to different types. In addition, the embodiments described below are merely some but not all of the embodiments of the present disclosure. All other embodiments obtained by a person skilled in the art based on the embodiments of the present disclosure without creative efforts shall fall within the protection scope of this disclosure.

With a rapid development of data storage technologies, users have increasing requirements for data storage, especially in cloud computing application scenarios, there is often a large amount of data to be stored and calculated. In order to satisfy requirements of the user for storing a large amount of data, a data storage system may be expanded, for example, the number of disks is increased. For a higher requirement of multiple read and write rates, some disks may need to be upgraded to a new model of disks with better performance. By iteratively upgrading disk products in the storage system, multiple disks of different manufacturers or different models may be included meanwhile. As the number of disks in the storage system becomes larger and larger, the requirements for operation and maintenance are also higher and higher. Therefore, in order to facilitate the operation and maintenance for the data storage system by a field staff, it is generally necessary to provide association relationships of each disk in the storage system and disk information of each disk itself, so that a target disk can be quickly locked and fault interference can be eliminated according to the association relationship and the disk information when a problem occurs. It is easy to understand that, in order to clarify the association relationships of all disks in the storage system, it is necessary to collect disk information of different manufacturers and upstream and downstream information or disk information of different models and upstream and downstream information. However, the collection of some information needs to be supported by the device manufacturers such as disks device manufacturer, and corresponding information collection programs need to be developed specifically for disks of different manufacturers or different models, resulting in increased information collection costs and low working efficiency. Therefore, there is a need for a solution that can quickly collect disk information in the storage system without depending on the support of manufacturers. In the technical solutions of the present disclosure, a specific working process is described in the following embodiments.

Terms Explanation:
Sever: a kind of computer, and an important part of a data center.
Storage link: a path taken by an Input/Output (IO) from issuing by an application to falling into a storage medium.
Just a Bunch Of Disks (JBOD): a storage device mounted on a bottom plate with a plurality of disk drives. Generally, JBOD is also referred to as Span. Unlike Redundant Arrays Of Independent Disks (RAID) arrays, JBOD does not have front-end logic to manage distribution of data across the disks, rather, each disk is individually addressed as a separate storage resource, either based on a part of a host software, or as an adapter card of a RAID group.
Host Bus Adapter (HBA): referred to as an adapter for short in this disclosure, which is a circuit board or an integrated circuit adapter that provides input/output (I/O) processing and physical connection between a server and a storage apparatus.
Expander: an apparatus that implements hard disk expansion.
Serial Attached SCSI (SAS): i.e., serial SCSI technology, which is a disk connection technology, integrates advantages of parallel SCSI and serial connection technology (such as Fibre Channel (FC), Serial Storage Architecture (SSA), IEEE1394, etc.), uses serial communication protocol as protocol infrastructure, adopts SCSI-3 extended instruction set, is compatible with SATA devices, and is a multi-level protocol stack for storage device connection.

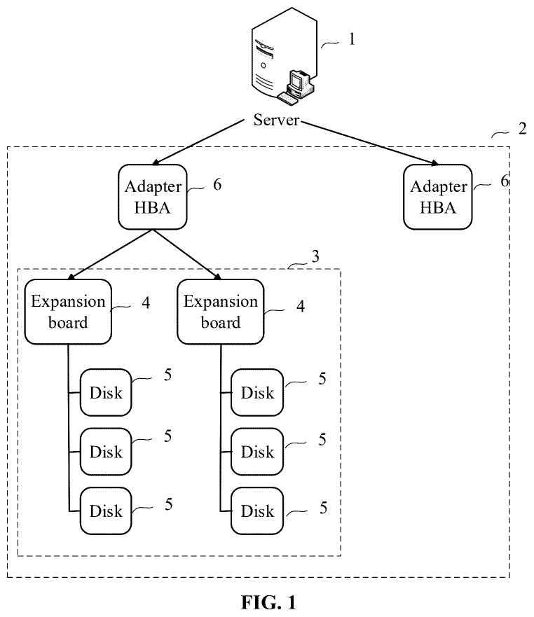

FIG. 1 is a schematic structural diagram of a data storage system according to an embodiment of the present disclosure. As can be seen from FIG. 1, the data storage system includes a server 1 and a storage cabinet 2. The storage cabinet 2 includes a plurality of Just a Bunch Of Disks (JBODs) 3, and each of the JBODs is provided with a plurality of expanders 4. Each expander 4 is connected with a plurality of disks 5. The server 1 is connected to the expanders 4 in the storage cabinet 2 through a plurality of adapters (HBAs) 6.

It can be seen from FIG. 1 that when the number of disks is not large, the user can easily clarify the location relationships of the disks in the storage system. However, if the number of disks is large, it is necessary to clarify the topological relationships of each disk in the storage system by auxiliary means such as a topological structure diagram.

In an implementation, in the storage system, a connection order from bottom to top is: disk, expander, adapter and server. However, when the number of disks is large, more expanders are required to help expand the storage system. For example, master-slave relationships of the expanders may be established, that is, master expanders are configured to establish connection relationships with the server through the adapters, and establish connection relationships with underlying disks through a plurality of slave expanders. It should be noted that each master expander can manage a limited number of slave expanders, and each of the slave expanders can support a limited number of disks. When there are more expansion requirements, the number of adapters can be increased. After the number of adapters is increased, the number of disks will also be multiplied correspondingly. The topological relationship of the storage system becomes more complex. For ease of management, a topological structure diagram corresponding to the storage system needs to be generated, or an existing topological structure diagram needs to be updated. In this case, the existing disks do not need to be replaced with the same model or brand as the newly added disks to ensure disk consistency in the storage system, instead, an open source normalization manner may be used to effectively reduce expansion costs of the storage system, and costs of combing and maintaining topological relationships of the storage system.

In brief, the open source normalization manner is: firstly, directly acquiring disk information of all disks in the storage system, where the information is in a scattered state, and the topological relationships of each disk cannot be clarified only according to the disk information. A further query needs to be performed according to disk identifier in the disk information to query an SAS address of an expander as an upstream device and a device number of an adapter HBA. An adapter port address corresponding to the adapter HBA is further determined based on the device number. It should be noted that the SAS address of the upstream expander, which can be queried according to the disk identifier, is the SAS address of the expander having an upstream and downstream relationship with the disk, and the device number of the adapter HBA, which can be found, is the device number of the adapter HBA having an upstream and downstream connection relationship with the certain expander having the SAS address. Therefore, a topological structure diagram depicting the topological relationship of the disks in the storage system may be generated based on the corresponding relationships among the disk port addresses of the disks, the expander port addresses, and the adapter port addresses. Of course, in practical applications, it may not be represented in a form of the topological structure diagram, but by a table or a string of information.

It should be noted that information such as the disk identifier and the device number may change because the device is restarted or some misalignment occurs. For example, there may be situations where the same disk identifier is used. When the topological relationships of the disks are displayed in the form of the topological structure diagram or the table, in order to avoid adverse effects caused by errors in information such as the disk identifier and the device number, in addition to displaying the disk identifier and the device number, related device information with unique identifiers such as a disk serial number, an expander serial number, a JBOD serial number, and an adapter PCI address are also displayed in the topological relationship. Even if an error occurs in the disk identifier, the user may also perform verification based on the disk serial number, thereby effectively improving information accuracy.

The following describes the technical solutions implemented in this disclosure with reference to specific embodiments.

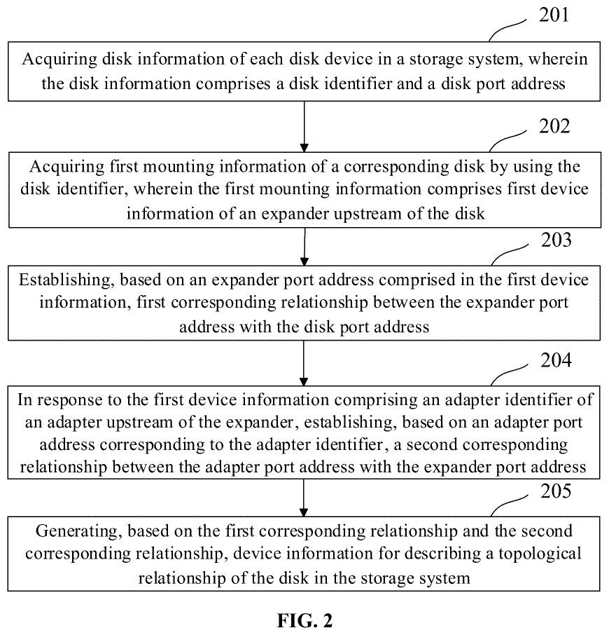

FIG. 2 is a schematic flowchart of a method for acquiring information in a storage system according to an embodiment of the present disclosure. The method may be executed by a server (including a local server or a cloud server), and the storage system may be the system shown in FIG. 1 or adaptively improved based on the system shown in FIG. 1 according to actual requirements, for example, adding master-slave hierarchical relationship of expanders. It can be seen from FIG. 2 that the following steps are included.

In step 201, disk information of each disk device in a storage system is acquired, where the disk information includes a disk identifier and a disk port address.

In step 202, first mounting information of a corresponding disk is acquired by using the disk identifier, where the first mounting information includes first device information of an expander upstream of the disk.

In step 203, based on an expander port address included in the first device information, a first corresponding relationship is established with the disk port address.

In step 204, in response to the first device information including an adapter identifier of an adapter upstream of the expander, based on an adapter port address corresponding to the adapter identifier, a second corresponding relationship is established with the expander port address.

In step 205, based on the first corresponding relationship and the second corresponding relationship, device information is generated for describing a topological relationship of the disk in the storage system.

As described above and in FIG. 1, the storage system includes a plurality of disks, and the management is difficult due to the large number of these disks. And if a certain disk is to be found (for example, it is suspected that the certain disk fails), it needs to be located according to the topological relationship thereof. If it is found through troubleshooting that the disk is not faulty, fault troubleshooting needs to be performed on the expander and the HBA upstream of the disk. And if there is a clear topological relationship, the expander and the HBA to be checked can be easily locked. Therefore, it is necessary to comb out the topological relationship among disks, expanders and adapters in the storage system.

In an actual application, the server may actively perform combing, or may perform combing according to a received request from the user. Firstly, the server acquires disk information of all underlying disks in a traversal manner, where the information includes disk identifiers, disk port addresses, disk identifier mapping tables, disk firmware versions, disk serial numbers, and the like of the disks.

In an implementation, the device information of each device upstream of the disk in the storage system needs to be acquired. For example, the first mounting information is queried according to the disk identifier by using a query instruction, and the queried first mounting information includes information related to upstream devices, for example, the first device information (for example, a device number and an expander port address) of expanders of each hierarchy in the upstream, and a device number of the adapter HBA. It should be noted herein that the expander corresponding to the acquired first device information is a direct upstream expander that belongs to the same JBOD as the disk corresponding to the disk identifier, and expanders in an indirect upstream relationship in the same JBOD cannot be queried based on the disk identifier. If the expanders have a plurality of hierarchies, a further distinguishment is required, which will be specifically described in the following embodiments, and will not be repeated here. Therefore, the first corresponding relationship may be established between the expander port address of the expander found by using the disk identifier and the disk port address corresponding to the disk identifier, and then an expander (when the expanders have a plurality of hierarchies) or an adapter HBA upstream of the found expander may be further searched for by using information related to the found expander.

As described above, because this solution does not need a third party (a hardware device manufacturer) to provide a support, information of the adapter HBA cannot be directly acquired. To further acquire the topological relationship of the adapter HBA, it needs to be implemented by means of the expander. In an implementation, when the mounting information is collected for a certain expander, a lot of information will be collected, including device information of the expander itself, for example, the expander port address, and basic information of a device that has the upstream and downstream relationship with the expander, for example, an adapter identifier of an upstream adapter or an expander device number of an upstream expander. Because the acquired first device information includes all information for 36 ports of the expander and further includes information related to upstream and downstream devices, a determination for the device information is needed. It is determined whether the first device information includes the adapter identifier of the upstream adapter, and if the first device information includes the adapter identifier, it indicates that the expander has the upstream adapter, and the adapter port address of the adapter may be further searched for according to the adapter identifier. Otherwise, if the adapter identifier is not found in the device information, it means that there is not an upstream adapter. Further, a second corresponding relationship is established with the downstream expander port address according to the searched adapter port address of the upstream adapter.

Through the above steps, the first corresponding relationship between the disk port address and the expander port address in the storage system and the second corresponding relationship between the expander port address and the adapter port address are obtained, and then the corresponding relationship among the disk port address, the expander SAS address and the adapter port address can be known. The corresponding relationship herein may be understood as that in the topological structure corresponding to the storage system, the disk, the expander, and the adapter have an upstream and downstream topological relationship.

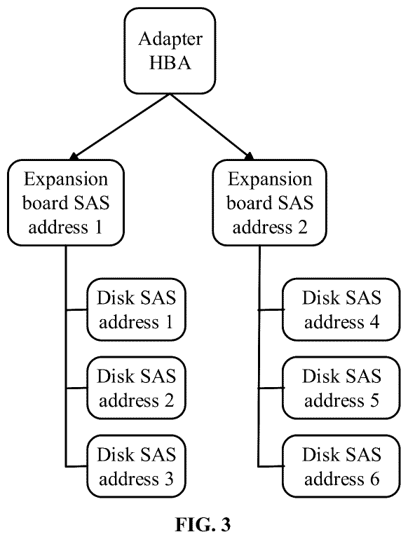

FIG. 3 is a schematic diagram of a topological relationship according to an embodiment of the present disclosure. Based on the foregoing solution, it is obtained that a disk port address 1 of a first disk, a disk port address 2 of a second disk, and a disk port address 3 of a third disk all correspond to an expander port address 1 of a first expander; and a disk port address 4 of a fourth disk, a disk port address 5 of a fifth disk, and a disk port address 6 of a sixth disk all correspond to an expander port address 2 of a second expander. Meanwhile, it is also obtained that an expander port address address 1 and the expander port address 2 correspond to the adapter port address 1 of the upstream adapter. The topological structure diagram for describing the topological relationship of the storage system shown in FIG. 3 may be obtained through the above corresponding relationship.

In the solution of the present disclosure, there is no need for a third party manufacturer (for example, a disk manufacturer) to provide a software tool for extracting disk information. Instead, the server acquires the device information (including the expander port address) of the upstream expanders layer by layer based on available disk information (including the disk identifier and the disk port address), and further acquires the device information (including the adapter port address) of the adapter upstream of the expander based on the device information of the expander. In a case that the software tool of the third party manufacturer is not used, the server cannot directly acquire complete topological relationships through the adapter HBA, but instead needs to acquire the device information layer by layer from bottom to top, and then deduce the topological relationship of the disk in the storage system. It is no need to depend on the manufacturer any more, and even for a storage system constructed by disks of different manufacturers, its topological relationship can easily be obtained, thereby improving device maintenance efficiency.

In one or more embodiments of the present disclosure, the method further includes: in response to the first device information including the adapter identifier of the adapter upstream of the expander, determining that the expander is a master expander; and
in response to the first device information not including the adapter identifier of the adapter upstream of the expander, determining that the expander is a slave expander.

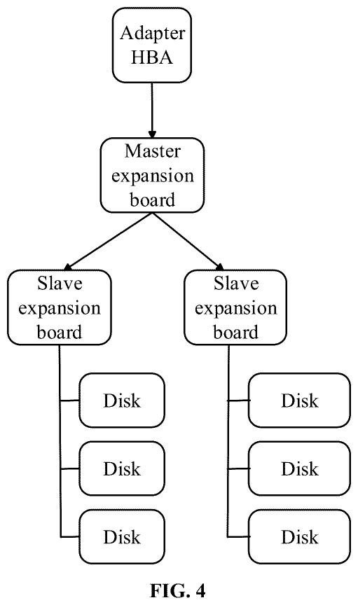

In order to improve the efficiency of combing the topological relationship, the adapter identifier may be checked for a specific flag bit in the obtained device information. For example, it is checked whether an adapter identifier “SSP+STP+SMP” is included in a specified identifier bit of a certain piece of information in the device information; if the adapter identifier “SSP+STP+SMP” is included, it can be learned that the current expander is a master expander; and if the adapter identifier “SSP+STP+SMP” is not included, it can be learned that the current expander is a slave expander. FIG. 4 is a schematic diagram of a topological relationship according to an embodiment of the present disclosure. As can be seen in FIG. 4, the expanders are divided into two stages: a master expander and a slave expander. The adapter HBA is connected to a master expander downstream thereof, a downstream of the master expander is a slave expander, and further, the slave expander is connected to the underlying disks. When the first device information of the expander is acquired, upstream information included in the first device information acquired based on the master expander is the device information of the adapter, and the upstream information acquired based on the slave expander is the device information of the master expander. When the disk information is acquired, the master-slave relationship of the expanders cannot be distinguished, and here (the corresponding solution in FIG. 4), a master-slave identity of the current expander can be determined according to the acquired upstream information. Without the support of the software tool of the third party manufacturer, the master-slave topological relationship of the current extender can be determined according to the device information and the acquired upstream device information. Therefore, the efficiency of combing the topological relationship is improved.

In one or more embodiments of the present disclosure, the expander port address of the expander is acquired according to the first device information which includes:
in response to the first device information being device information of the master expander, acquiring a first master Serial Attached SCSI (SAS) address and a first slave SAS address of a slave expander downstream of the master expander according to the first device information; or
in response to the first device information being device information of the slave expander, acquiring the first slave SAS address and the first master SAS address of the master expander upstream of the slave expander according to the first device information.

It can be learned from the above descriptions that the master expander and the slave expander that have the upstream and downstream topological relationship may be determined through the above steps. For expanders at different hierarchies, after determining hierarchy types of the expanders and the hierarchical relationships in the topological structure, the expanders at different hierarchies further acquire other information having upstream and downstream topological relationships with the expanders.

In practical applications, for each expander, the SAS address of the expander, and the first master SAS address of the upstream master expander corresponding to the expander or the first slave SAS address of the downstream slave expander corresponding to the expander may be acquired, respectively. Therefore, relatively comprehensive SAS addresses can be acquired, and then can be verified with each other. If the verification result is correct, a topological relationship between one first master SAS address and a plurality of first slave SAS addresses is determined. For example, the SAS addresses of the downstream expander acquired based on the first master SAS address 1 include: a first slave SAS address 1, a first slave SAS address 2, and a first slave SAS address 3. And the first master SAS address 1 of a corresponding upstream expander is acquired based on the first slave SAS address 1. The first master SAS address 1 of a corresponding upstream expander is acquired based on the first slave SAS address 2. And the first master SAS address 2 of a corresponding upstream expander is acquired based on the first slave SAS address 3. It can be learned through verification that the topological relationship between the first master SAS address 1 and the first slave SAS address 1 is correct, the topological relationship between the first master SAS address 1 and the first slave SAS address 2 is correct, but the topological relationship between the first master SAS address 1 and the first slave SAS address 3 is incorrect, and further verification needs to be performed (for example, the above steps are repeated). In the above manner, the plurality of expanders separately acquire corresponding addresses and port addresses of upstream and downstream expanders, so that mutual verifications of SAS addresses can be implemented between different expanders, thereby effectively improving accuracy of the topological relationship.

In one or more embodiments of the present disclosure, the method further includes: determining a target flag bit of the adapter and a flag in the target flag bit; in response to the first device information including the adapter identifier located in the target flag bit, determining second device information of the adapter upstream of the expander, where the second device information includes the adapter port address.

In practical applications, there are many contents of the first device information, including the device number of the expander itself, the device port information, and information related to upstream and downstream devices. If there are many device ports, there will be more information contents, and therefore, in order to improve the efficiency of combing the topological relationship, the adapter identifier may be checked for a specific flag bit in the obtained device information. For example, it is checked whether the adapter identifier “SSP+STP+SMP” is included in a specified identifier bit of a certain piece of information in the device information; if the adapter identifier “SSP+STP+SMP” is included, it can be learned that the current expander is a master expander. Of course, there is also a case where there is only one expander hierarchy and there is no hierarchical topological relationship of the master expander or the slave expander. After the adapter identifier of the upstream adapter connected to the expander is found, the second device information of the adapter is further acquired according to the adapter identifier, and the adapter port address corresponding to the adapter is searched for in the second device information. Therefore, the second corresponding relationship is established based on the expander port address and the adapter port address.

Since support provided by a third party (hardware manufacturer) is unavailable, the server cannot directly obtain the adapter port address of the adapter in the storage system through the adapter HBA, and needs to acquire the adapter port address indirectly through the expander. Based on the above descriptions, after the expander port address and the first device information corresponding to the expander have been acquired, the adapter port address of the adapter is further searched for based on the adapter identifier included in the first device information, to establish the topological relationship based on the searched adapter port address. Based on the above solution, the adapter port address is acquired without being supported by the third party, to establish the topological relationship of the storage system. Even if, in some cases, there are adapters of different manufacturers or adapters of different models in the storage system, the above solution may be used to find the port address of an adapter upstream of the expander, thereby effectively improving efficiency of acquiring the topological relationship of the storage system.

In one or more embodiments of the present disclosure, the disk information further includes a disk identifier mapping table.

The method further includes: in response to the expander being the slave expander, determining a slave expander port address corresponding to the slave expander; searching for, according to the first corresponding relationship, a slave device number corresponding to the slave expander port address from the disk identifier mapping table; accessing, based on the slave device number, a mounting information page corresponding to the slave expander; querying, from the mounting information page corresponding to the slave expander, Just a Bunch Of Disks (JBOD) where the slave expander is located and a serial number of the JBOD.

Based on the above technical solutions, if it is determined that the current expander is a slave expander, the slave expander port address is further acquired. According to the disk port address, the expander port address, and the adapter port address respectively included in the first corresponding relationship and the second corresponding relationship, the topological relationship among each disk and the upstream expander and adapter may be established.

The previously acquired disk information of the disk includes the disk identifier mapping table. And the disk identifier mapping table includes not only the disk identifier of the disk, but also the device number of the expander upstream of the disk. Further, after the complete topological relationship of the disk is obtained based on the above description, a device number of an expander corresponding to a disk identifier may be searched for from the disk identifier mapping table according to the topological relationship.

A specific manner of searching for the device number of the expander is as follows: determining, according to the first corresponding relationship, the disk port address corresponding to the slave expander port address; searching for, in the disk identifier mapping table by using the disk identifier corresponding to the disk port address, the slave device number corresponding to the slave expander.

In practical applications, based on the slave device number, a mounting information page corresponding to the slave expander is accessed; and a Just a Bunch Of Disks (JBOD) where the slave expander is located and a JBOD serial number corresponding to the JBOD are queried from the mounting information page corresponding to the slave expander. The reason why the JBOD and the corresponding JBOD serial number need to be acquired herein is to facilitate on-site operation and maintenance personnel of the storage system to quickly search for and lock a target disk (for example, a fault disk). If only the disk identifier of the disk is provided for the operation and maintenance personnel, because the number of the disks is too large, the operation and maintenance personnel cannot quickly lock a disk position according to the disk identifier. Therefore, while providing the operation and maintenance personnel with the disk identifier of the disk, the operation and maintenance personnel are further provided with the JBOD to which the disk identifier belongs and the serial number of the JBOD, so that in the case that the operation and maintenance personnel can quickly lock the JBOD, the fault disk corresponding to the disk identifier is further searched for from the JBOD, which can effectively improve the working efficiency of locking the disk during troubleshooting. In addition, in a case that the support of the third party manufacturer is not obtained, the server cannot directly acquire the detailed information related to the JBOD, but can collect the detailed information of JBOD based on the expander, thereby avoiding the dependence on the third party. The above solution has better universality and can be applied to the collection of information related to the JBOD of various manufacturers or models.

In one or more embodiments of the present disclosure, the method further includes: querying a Peripheral Component Interconnect (PCI) address of the adapter upstream of each disk device according to the disk identifier.

In practical applications, while the device number of the HBA is provided for the user, the PCI address is further provided for the user, so that the user comprehensively confirms the topological relationship of the adapter and the position of the adapter in the topological relationship through multiple pieces of information. In some cases, the device number of the adapter HBA may be changed abruptly or misaligned, resulting in an inaccurate device number, but the PCI address of each HBA is unique and does not change. When the HBA needs to be positioned, the field staff needs to perform accurate positioning according to the PCI address.

For example, when an adapter HBA fails, it may be due to the adapter HBA itself or multiple factors (both the adapter and extender fail), therefore, while the PCI address of the HBA is provided, the information related to other devices that have the topological relationship with the adapter HBA is also provided.

When describing the overall topological relationship of the storage system, the PCI address of the adapter is displayed in the topological relationship, which facilitates the user to accurately locate the adapter and verify the accuracy of the topological relationship. Without obtaining the support of the third party manufacturer, adding the PCI address of the adapter HBA can effectively facilitate the user to verify the accuracy of the topological relationship, and further can improve the accuracy of the topological relationship.

In one or more embodiments of the present disclosure, the method further includes: generating, according to the first corresponding relationship and the second corresponding relationship, a topological structure diagram for describing upstream and downstream topological relationships of the disk and the expander and the adapter upstream of the disk; where upstream and downstream connection relationships are described by edges in the topological structure diagram, and the disk information and the first device information are described by nodes in the topological structure diagram.

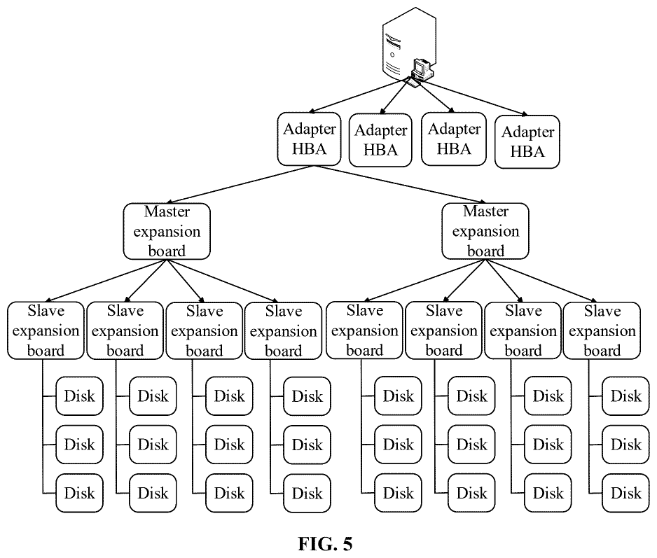

FIG. 5 is a schematic diagram of a topological structure according to an embodiment of the present disclosure. The topological structure relationship of the entire storage system can be seen from FIG. 5, including: two servers, where the server 1 establishes connection relationships with downstream expanders through four adapters. There is one master expander downstream of each adapter, and four slave expanders downstream of the master expander. Further, a plurality of disks are connected downstream of each slave expander. When there is an expansion requirement, a disk may be directly added under the slave expander. If the number of disks downstream of the slave expander has been saturated, a slave expander may be added. If the number of slave expanders downstream of the master expander is saturated, a master expander may be added downstream of the adapter, or an adapter may be added, and the corresponding downstream device may be expanded. After expansion, the topological relationship of the storage system will also become more complex, and the topological structure diagram can be quickly updated by the manner described in the above embodiments.

In the topological structure diagram shown in FIG. 5, it can be seen that different types of device nodes, including adapter nodes, master extender nodes, slave extender nodes, and disk nodes, are represented by different images or graphs. In addition, the device information, for example, the disk identifier, the device serial number, and the SAS address, may be added to each device node according to requirements, to help the user verify the accuracy of the topological relationship. The edges used for connecting different device nodes indicate that there is a direct upstream and downstream relationship between two device nodes connected through each of the edges. By establishing the topological structure diagram, the structural relationship is more obvious.

In an actual application, if troubleshooting needs to be performed, based on the topological structure diagram, and only by inputting the disk identifier, the user can be provided with the specific topological relationship and specific information (for example, the disk serial number, the device type of the upstream device, the serial number, and the SAS address) corresponding to the disk identifier.

In one or more embodiments of the present disclosure, the method further includes: querying, according to the disk identifier, version information and a disk serial number corresponding to the disk; and establishing an association relationship between the disk identifier and the disk serial number.

In practical applications, the number of disks in the storage system is much larger than the number of expanders and adapters. In order to facilitate the user to understand the disk information, the disk identifier of each disk will be provided according to a disk naming rule, but the disk identifier is not unique, so it is also necessary to query unique related information of each disk, including version information and disk serial number. Then, the association relationship between the disk identifier and the disk serial number is established. When searching for a disk, as long as any piece of information of the disk is found, other more detailed information of the disk can be acquired according to the association relationship. When being displayed by the topological structure diagram, more detailed disk information of each device node may be further displayed, including the disk identifier of the disk, the disk serial number, the disk version information, and the like. It is convenient for the user to use the information to verify the accuracy of the topological relationship while understanding the detailed information.

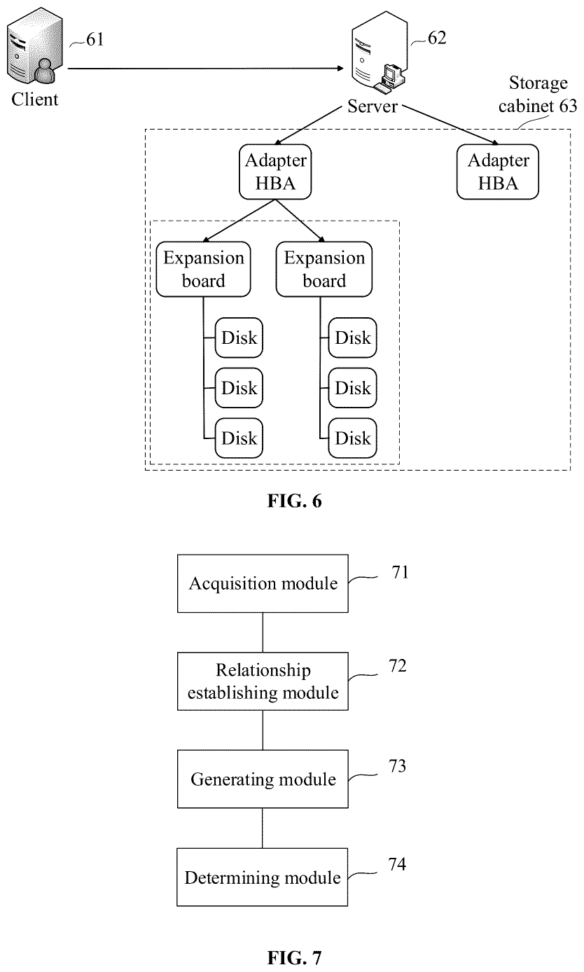

Based on the same idea, an embodiment of the present disclosure further provides a data storage system. FIG. 6 is a schematic structural diagram of a data storage system according to an embodiment of the present disclosure. As can be seen from FIG. 6, the system includes:
a client 61, configured to send a request for acquiring device information to a server;
a server 62, configured to: in response to the request for acquiring device information, acquire disk information of each disk device in a storage system, where the disk information includes a disk identifier and a disk port address; acquire first mounting information of a corresponding disk by using the disk identifier, where the first mounting information includes first device information of an expander upstream of the disk; establish, based on an expander port address included in the first device information, a first corresponding relationship between the expander port address with the disk port address; in response to the first device information including an adapter identifier of an adapter upstream of the expander, establish, based on an adapter port address corresponding to the adapter identifier, a second corresponding relationship between the adapter port address with the expander port address; and generate, based on the first corresponding relationship and the second corresponding relationship, device information for describing a topological relationship of the disk in the storage system; and
a storage cabinet 63, including the adapter, the expander, and the disk, and configured to be connected to the server through one or more adapters, where one or more expanders and a plurality of disks are sequentially connected downstream of each of the adapters.

The data storage system includes many disks for storing data, and expanders and adapters for managing the disks and assisting in data processing. The system structure is complex, and in order to facilitate the user to understand the topological structure relationship of the data storage system and facilitate subsequent management of operation and maintenance personnel, the embodiments described in FIG. 1 to FIG. 5 may be used to comb the topological relationship of the storage system and generate the topological structure diagram for describing the topological relationship of each device node in the storage system. The device information may be displayed to the user by the topological structure diagram. For details, reference may be made to the above embodiments, and details are not described herein again.

Based on the same idea, an embodiment of the present disclosure further provides an apparatus for acquiring device information. FIG. 7 is a schematic structural diagram of an apparatus for acquiring device information according to an embodiment of the present disclosure. As can be seen from FIG. 7, the apparatus includes:
an acquisition module 71, configured to acquire disk information of each disk device in a storage system, where the disk information includes a disk identifier and a disk port address;
where the acquisition module 71 is further configured to acquire first mounting information of a corresponding disk by using the disk identifier, where the first mounting information includes first device information of an expander upstream of the disk;
a relationship establishing module 72, configured to establish, based on an expander port address included in the first device information, a first corresponding relationship between the expander port address with the disk port address;
where the relationship establishing module 72 is further configured to, in response to the first device information including an adapter identifier of an adapter upstream of the expander, establish, based on an adapter port address corresponding to the adapter identifier, a second corresponding relationship between the adapter port address with the expander port address; and
a generating module 73, configured to generate, based on the first corresponding relationship and the second corresponding relationship, device information for describing a topological relationship of the disk in the storage system.

In an implementation, the apparatus further includes: a determining module 74, configured to, in response to the first device information including the adapter identifier of the adapter upstream of the expander, determine that the expander is a master expander; and
in response to the first device information not including the adapter identifier of the adapter upstream of the expander or the first device information including device information of a master expander upstream of the expander, determine that the expander is a slave expander.

Where the acquisition module 71 is further configured to, in response to the first device information being device information of the master expander, acquire a first master Serial Attached SCSI (SAS) address and a first slave SAS address of a slave expander downstream of the master expander according to the first device information; or
in response to the first device information being device information of the slave expander, acquire the first slave SAS address and the first master SAS address of the master expander upstream of the slave expander according to the first device information.

The determining module 74 is further configured to: determine a target flag bit of the adapter and a flag in the target flag bit;
in response to the first device information including the adapter identifier located in the target flag bit, determine second device information of the adapter upstream of the expander, where the second device information includes the adapter port address.

In an implementation, the disk information further includes a disk identifier mapping table.

The determining module 74 is further configured to, in response to the expander being the slave expander, determine a slave expander port address corresponding to the slave expander;
search for, according to the first corresponding relationship, a slave device number corresponding to the slave expander port address from the disk identifier mapping table;
access, based on the slave device number, a mounting information page corresponding to the slave expander;
query, from the mounting information page corresponding to the slave expander, Just a Bunch Of Disks (JBOD) where the slave expander is located and a serial number of the JBOD.

In an implementation, the determining module 74 is further configured to: determine, according to the first corresponding relationship, the disk port address corresponding to the slave expander port address;
search for, in the disk identifier mapping table by using the disk identifier corresponding to the disk port address, the slave device number corresponding to the slave expander.

In an implementation, the acquisition module 71 is further configured to, query a Peripheral Component Interconnect (PCI) address of the adapter upstream of each disk device according to the disk identifier.

In an implementation, the generating module 73 is configured to generate, according to the first corresponding relationship and the second corresponding relationship, a topological structure diagram for describing upstream and downstream topological relationships of the disk and the expander and the adapter upstream of the disk;

Where upstream and downstream connection relationships are described by edges in the topological structure diagram, and the disk information and the first device information are described by nodes in the topological structure diagram.

In an implementation, the relationship establishing module 72 is further configured to: query, according to the disk identifier, version information and a disk serial number corresponding to the disk; and
establish an association relationship between the disk identifier and the disk serial number.

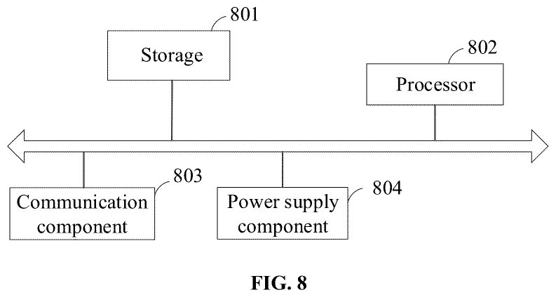

An embodiment of the present disclosure further provides an electronic device. The electronic device is a master node electronic device in a computing unit. FIG. 8 is a schematic structural diagram of an electronic device according to an embodiment of the present disclosure. The electronic device includes a storage 801, a processor 802, and a communication component 803.
the storage 801 is configured to store a program;

The processor 802 is coupled to the storage, and is configured to execute the program stored in the storage, to:
acquire disk information of each disk device in a storage system, where the disk information includes a disk identifier and a disk port address;
acquire first mounting information of a corresponding disk by using the disk identifier, where the first mounting information includes first device information of an expander upstream of the disk;
establish, based on an expander port address included in the first device information, a first corresponding relationship between the expander port address with the disk port address;
in response to the first device information including an adapter identifier of an adapter upstream of the expander, establish, based on an adapter port address corresponding to the adapter identifier, a second corresponding relationship between the adapter port address with the expander port address; and
generate, based on the first corresponding relationship and the second corresponding relationship, device information for describing a topological relationship of the disk in the storage system.

In an implementation, the processor 802 is further configured to: in response to the first device information including the adapter identifier of the adapter upstream of the expander, determine that the expander is a master expander; and
in response to the first device information not including the adapter identifier of the adapter upstream of the expander or the first device information including device information of the master expander upstream of the expander, determine that the expander is a slave expander.

In an implementation, the processor 802 is further configured to: in response to the first device information being device information of the master expander, acquire a first master Serial Attached SCSI (SAS) address and a first slave SAS address of a slave expander downstream of the master expander according to the first device information; or
in response to the first device information being device information of the slave expander, acquire the first slave SAS address and the first master SAS address of the master expander upstream of the slave expander according to the first device information.

In an implementation, the processor 802 is further configured to: determine a target flag bit of the adapter and a flag in the target flag bit;
in response to the first device information including the adapter identifier located in the target flag bit, determine second device information of the adapter upstream of the expander, where the second device information includes the adapter port address.

In an implementation, the disk information further includes a disk identifier mapping table; and the processor 802 is further configured to: in response to the expander being the slave expander, determine a slave expander port address corresponding to the slave expander;
search for, according to the first corresponding relationship, a slave device number corresponding to the slave expander port address from the disk identifier mapping table;
access, based on the slave device number, a mounting information page corresponding to the slave expander; and
query, from the mounting information page corresponding to the slave expander, Just a Bunch Of Disks (JBOD) where the slave expander is located and a serial number of the JBOD.

In an implementation, the processor 802 is further configured to: determine, according to the first corresponding relationship, the disk port address corresponding to the slave expander port address;
search for, in the disk identifier mapping table by using the disk identifier corresponding to the disk port address, the slave device number corresponding to the slave expander.

In an implementation, the processor 802 is further configured to: query a Peripheral Component Interconnect (PCI) address of the adapter upstream of each disk device according to the disk identifier.

In an implementation, the processor 802 is configured to generate, according to the first corresponding relationship and the second corresponding relationship, a topological structure diagram for describing upstream and downstream topological relationships of the disk and the expander and the adapter upstream of the disk;

Where upstream and downstream connection relationships are described by edges in the topological structure diagram, and the disk information and the first device information are described by nodes in the topological structure diagram.

In an implementation, the processor 802 is further configured to: query, according to the disk identifier, version information and a disk serial number corresponding to the disk; and establish an association relationship between the disk identifier and the disk serial number.

The storage 801 may be configured to store various other data to support operations on the electronic device. Examples of such data include instructions for any application or method operating on the electronic device. The storage may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

In an implementation, the processor 802 in this embodiment may be specifically a programmable switching processing chip, where a data replication engine is configured in the programmable switching processing chip, and can replicate received data.

When executing the program in the storage, the processor 802 may further implement other functions in addition to the above functions, and for details, refer to the descriptions in the above embodiments. In an implementation, as shown in FIG. 8, the electronic device further includes a power supply component 804 and other components.

An embodiment of the present disclosure further provides a non-transitory machine-readable storage medium having executable codes stored thereon, the executable codes, when executed by a processor of an electronic device, causing the processor to perform the method according to the embodiment corresponding to FIG. 2.

Based on the above embodiment, the storage system includes many disks used to store data. To facilitate management of the disks, the disks are grouped by using the expanders and the JBODs. And there are a plurality of adapters upstream of the expanders, to satisfy data transmission between the server and the disks. When the topological relationship of each device node in the storage system is to be acquired, basic information such as disk information is collected without being supported by the device hardware manufacturer. Then the first device information of the expander upstream of the disk and the expander port address are searched for according to the basic information such as the disk identifier and the disk port address in the disk information. Then, the adapter port address of the adapter upstream of the expander is searched for by using the first device information. The device information for describing the topological relationship between device nodes in the storage system may be obtained by combing upstream and downstream information. In this solution of the present disclosure, the information related to underlying disks included in the storage system, including the disk identifier and the disk port address, is acquired. And further, the expander port address of the expander that has an upstream and downstream relationship with the disk and the adapter port address of the adapter upstream of the expander continue to be searched for according to the disk identifier. It should be noted that, when the information related to upstream and downstream devices is searched for according to the disk identifier, the expander and the adapter that have the upstream and downstream relationship can be acquired, and information of the expander and the adapter that do not have the upstream and downstream relationship with the disk in different branches cannot be acquired.

In technical solutions provided in the embodiments of the present disclosure, the storage system includes many disks used to store data. To facilitate management of the disks, the disks are grouped by using the expanders and the JBODs. And there are a plurality of adapters upstream of the expanders, to satisfy data transmission between the server and the disks. When the topological relationship of each device node in the storage system is to be acquired, basic information such as disk information is collected without being supported by the device hardware manufacturer. Then the first device information of the expander upstream of the disk and the expander port address are searched for according to the basic information such as the disk identifier and the disk port address in the disk information. Then, the adapter port address of the adapter upstream of the expander is searched for by using the first device information. The device information for describing the topological relationship between device nodes in the storage system may be obtained by combing upstream and downstream information. In this solution of the present disclosure, the information related to underlying disks included in the storage system, including the disk identifier and the disk port address, is acquired. And further, the expander port address of the expander that has an upstream and downstream relationship with the disk and the adapter port address of the adapter upstream of the expander continue to be searched for according to the disk identifier. It should be noted that, when the information related to upstream and downstream devices is searched for according to the disk identifier, the expander and the adapter that have the upstream and downstream relationship can be acquired, and information of the expander and the adapter that do not have the upstream and downstream relationship with the disk in different branches cannot be acquired.

The apparatus embodiments described above are merely illustrative, where the units described as separate components may or may not be physically separated, and the components displayed as units may or may not be physical units, that is, may be located in one place, or may be distributed on a plurality of network units. Some or all of the modules may be selected according to actual requirements to achieve the effects of the solutions of the embodiments. Those skilled in the art can understand and implement the embodiments of the present disclosure without creative efforts.

Based on the descriptions of the above implementations, those skilled in the art may clearly understand that the implementations may be implemented by software in addition to a necessary universal hardware platform, or by hardware. Based on this understanding, the above technical solution essentially or the part contributing to the related art may be embodied in the form of a software product, and the computer software product may be stored in a computer-readable storage medium, such as a ROM/RAM, a magnetic disk, an optical disk, etc., including several instructions to enable a computer device (which may be a personal computer, a server, or a network device, etc.) to execute the methods described in various embodiments or some parts of the embodiments.

Finally, it should be noted that the above embodiments are only used to illustrate the technical solutions of the present disclosure, but not to limit the present disclosure; although the present disclosure has been described in detail with reference to the above embodiments, those of ordinary skill in the art should understand that the technical solutions described in the above embodiments can still be modified, or some technical features thereof can be equivalently replaced; and these modifications or substitutions do not make the essence of the corresponding technical solutions deviate from the spirit and scope of the technical solutions of the embodiments of the present disclosure.

1. A method for acquiring information, applied to a server, comprising:
acquiring disk information of each disk device in a storage system, wherein the disk information comprises a disk identifier and a disk port address;
acquiring first mounting information of a corresponding disk by using the disk identifier, wherein the first mounting information comprises first device information of an expander upstream of the disk;
establishing, based on an expander port address comprised in the first device information, a first corresponding relationship between the expander port address with the disk port address;
in response to the first device information comprising an adapter identifier of an adapter upstream of the expander, establishing, based on an adapter port address corresponding to the adapter identifier, a second corresponding relationship between the adapter port address with the expander port address; and
generating, based on the first corresponding relationship and the second corresponding relationship, device information for describing a topological relationship of the disk in the storage system.

2. The method according to claim 1, further comprising:
in response to the first device information comprising the adapter identifier of the adapter upstream of the expander, determining that the expander is a master expander; and
in response to the first device information not comprising the adapter identifier of the adapter upstream of the expander or the first device information comprising device information of a master expander upstream of the expander, determining that the expander is a slave expander.

3. The method according to claim 2, wherein the expander port address of the expander is acquired according to the first device information, which comprises:
in response to the expander being a master expander, acquiring a first master Serial Attached SCSI (SAS) address of the master expander and a first slave SAS address of a slave expander downstream of the master expander according to the first device information; or
in response to the expander being a slave expander, acquiring a first slave SAS address of the slave expander and a first master SAS address of the master expander upstream of the slave expander according to the first device information.

4. The method according to claim 2, further comprising:
determining a target flag bit of the adapter and a flag in the target flag bit; and
in response to the first device information comprising the adapter identifier located in the target flag bit, determining second device information of the adapter upstream of the expander, wherein the second device information comprises the adapter port address.

5. The method according to claim 2, wherein the disk information further comprises a disk identifier mapping table;
the method further comprises:
in response to the expander being the slave expander, determining a slave expander port address corresponding to the slave expander;
searching for, according to the first corresponding relationship, a slave device number corresponding to the slave expander port address from the disk identifier mapping table;
accessing, based on the slave device number, a mounting information page corresponding to the slave expander; and
querying, from the mounting information page corresponding to the slave expander, Just a Bunch Of Disks (JBOD) where the slave expander is located and a serial number of the JBOD.

6. The method according to claim 5, wherein the searching for, according to the first corresponding relationship, a slave device number corresponding to the slave expander port address from the disk identifier mapping table comprises:
determining, according to the first corresponding relationship, the disk port address corresponding to the slave expander port address; and
searching for, in the disk identifier mapping table by using the disk identifier corresponding to the disk port address, the slave device number corresponding to the slave expander.

7. The method according to claim 1, wherein the method further comprises:
querying a Peripheral Component Interconnect (PCI) address of the adapter upstream of each disk device according to the disk identifier.

8. The method according to claim 1, further comprising:
generating, according to the first corresponding relationship and the second corresponding relationship, a topological structure diagram for describing upstream and downstream topological relationships of the disk and the expander and the adapter upstream of the disk;
wherein upstream and downstream connection relationships are described by edges in the topological structure diagram, and the disk information and the first device information are described by nodes in the topological structure diagram.

9. The method according to claim 1, wherein the method further comprises:
querying, according to the disk identifier, version information and a disk serial number corresponding to the disk; and
establishing an association relationship between the disk identifier and the disk serial number.

10. A data storage system comprising:
a client, configured to send a request for acquiring device information to a server;
a server, configured to:
in response to the request for acquiring device information, acquire disk information of each disk device in a storage system, wherein the disk information comprises a disk identifier and a disk port address;
acquire first mounting information of a corresponding disk by using the disk identifier, wherein the first mounting information comprises first device information of an expander upstream of the disk;
establish, based on an expander port address comprised in the first device information, a first corresponding relationship between the expander port address with the disk port address;
in response to the first device information comprising an adapter identifier of an adapter upstream of the expander, establish, based on an adapter port address corresponding to the adapter identifier, a second corresponding relationship between the adapter port address with the expander port address; and
generate, based on the first corresponding relationship and the second corresponding relationship, device information for describing a topological relationship of the disk in the storage system; and
a storage cabinet, comprising the adapter, the expander, and the disk, and configured to be connected to the server through one or more adapters, wherein one or more expanders and a plurality of disks are sequentially connected downstream of each of the adapters.

11. (canceled)

12. An electronic device, comprising a non-transitory storage and a processor, wherein:
the non-transitory storage is configured to store a program;
the processor is coupled to the non-transitory storage, and is configured to execute the program stored in the non-transitory storage, to implement following operations:
acquiring disk information of each disk device in a storage system, wherein the disk information comprises a disk identifier and a disk port address;
acquiring first mounting information of a corresponding disk by using the disk identifier, wherein the first mounting information comprises first device information of an expander upstream of the disk;
establishing, based on an expander port address comprised in the first device information, a first corresponding relationship between the expander port address with the disk port address;
in response to the first device information comprising an adapter identifier of an adapter upstream of the expander, establishing, based on an adapter port address corresponding to the adapter identifier, a second corresponding relationship between the adapter port address with the expander port address; and
generating, based on the first corresponding relationship and the second corresponding relationship, device information for describing a topological relationship of the disk in the storage system.

13. A non-transitory machine-readable storage medium having executable codes stored thereon, the executable codes, when executed by a processor of an electronic device, causing the processor to perform the method according to claim 1.

14. The electronic device according to claim 12, wherein the operations further comprise:
in response to the first device information comprising the adapter identifier of the adapter upstream of the expander, determining that the expander is a master expander; and
in response to the first device information not comprising the adapter identifier of the adapter upstream of the expander or the first device information comprising device information of a master expander upstream of the expander, determining that the expander is a slave expander.

15. The electronic device according to claim 14, wherein the expander port address of the expander is acquired according to the first device information, which comprises:
in response to the expander being a master expander, acquiring a first master Serial Attached SCSI (SAS) address of the master expander and a first slave SAS address of a slave expander downstream of the master expander according to the first device information; or
in response to the expander being a slave expander, acquiring a first slave SAS address of the slave expander and a first master SAS address of the master expander upstream of the slave expander according to the first device information.

16. The electronic device according to claim 14, wherein the operations further comprise:
determining a target flag bit of the adapter and a flag in the target flag bit; and
in response to the first device information comprising the adapter identifier located in the target flag bit, determining second device information of the adapter upstream of the expander, wherein the second device information comprises the adapter port address.

17. The electronic device according to claim 14, wherein the disk information further comprises a disk identifier mapping table;
the operations further comprise:
in response to the expander being the slave expander, determining a slave expander port address corresponding to the slave expander;
searching for, according to the first corresponding relationship, a slave device number corresponding to the slave expander port address from the disk identifier mapping table;
accessing, based on the slave device number, a mounting information page corresponding to the slave expander; and
querying, from the mounting information page corresponding to the slave expander, Just a Bunch Of Disks (JBOD) where the slave expander is located and a serial number of the JBOD.

18. The electronic device according to claim 17, wherein the searching for, according to the first corresponding relationship, a slave device number corresponding to the slave expander port address from the disk identifier mapping table comprises:
determining, according to the first corresponding relationship, the disk port address corresponding to the slave expander port address; and
searching for, in the disk identifier mapping table by using the disk identifier corresponding to the disk port address, the slave device number corresponding to the slave expander.

19. The electronic device according to claim 12, wherein the operations further comprise:
querying a Peripheral Component Interconnect (PCI) address of the adapter upstream of each disk device according to the disk identifier.

20. The electronic device according to claim 12, wherein the operations further comprise:
generating, according to the first corresponding relationship and the second corresponding relationship, a topological structure diagram for describing upstream and downstream topological relationships of the disk and the expander and the adapter upstream of the disk;
wherein upstream and downstream connection relationships are described by edges in the topological structure diagram, and the disk information and the first device information are described by nodes in the topological structure diagram.

21. The electronic device according to claim 12, wherein the operations further comprise:
querying, according to the disk identifier, version information and a disk serial number corresponding to the disk; and
establishing an association relationship between the disk identifier and the disk serial number.
